(19) United States
(12) Patent Application Publication
(10) Pub. No.: US 2024/0152876 A1
(43) Pub. Date: May 9, 2024

(54) ROAD DETERIORATION DIAGNOSIS DEVICE, ROAD DETERIORATION DIAGNOSIS METHOD, AND RECORDING MEDIUM

(71) Applicant: NEC Corporation, Minato-ku, Tokyo (JP)

(72) Inventors: Yosuke KIMURA, Tokyo (JP); Nana JUMONJI, Tokyo (JP); Chisato SUGAWARA, Tokyo (JP); Toru TAKAMI, Tokyo (JP); Hiroshi NAKASATO, Tokyo (JP)

(73) Assignee: NEC Corporation, Minato-ku, Tokyo (JP)

(21) Appl. No.: 18/281,664

(22) PCT Filed: Mar. 18, 2021
(86) PCT No.: PCT/JP2021/011139

§ 371 Date: Sep. 12, 2023

(51) Int. Cl. G06Q 10/20; G06T 7/00; G06V 20/56

(52) U.S. Cl. CPC G06Q 10/20; G06T 7/0002; G06V 20/588; G06T 2207/30184; G06T 2207/30252

(57) ABSTRACT

A road deterioration diagnosis device according to an aspect of the present disclosure includes: at least one memory configured to store instructions, deterioration information including a detection status of a pothole, and a maintenance status of the detected pothole in each section, the each section obtained by dividing a predetermined region by a predetermined size; and at least one processor configured to execute the instructions to cause a display to display a map indicating the deterioration information in the each section.

### TECHNICAL FIELD

The present disclosure relates to a road deterioration diagnosis device, a road deterioration diagnosis method, and a recording medium.

### BACKGROUND ART

A system that determines road deterioration by analyzing an image and acceleration collected by a traveling vehicle is known. For example, PTL 1 discloses a road surface status determination device that performs image processing on an image obtained by photographing a road surface to determine a state of the road surface. PTL 2 discloses a device that automatically detects a place in need of repair and displays the place on a map based on a detected road surface status.

When road deterioration is detected from information collected from vehicles, a business operator (local government or the like) that manages the road dispatches a worker to a place (site) where the road deterioration is detected, and maintains the road by confirming the current status or repairing the road after confirming. As a general maintenance scheme, the worker not only maintains only the detected road deterioration on site, but also confirms and repairs newly found road deterioration if finding other road deterioration around the road deterioration (e.g., a visually confirmable range).

### CITATION LIST

### Patent Literature

PTL 1: JP 2002-140789 A
PTL 2: JP 2018-154986 A

### SUMMARY OF INVENTION

### Technical Problem

In the device disclosed in PTL 2, each detected road deterioration is displayed on a map. That is, each road deterioration is managed as a place in need of repair. In general, in order to quickly find road deterioration in need of early repair, such as a pothole, the business operator detects road deterioration by repeatedly traveling a vehicle in a region. For this reason, when road deterioration concentratively occurs in a narrow range, in a case of managing each road deterioration, it is necessary to manage a large number of road deteriorations in the range, which is complicated. However, considering the maintenance scheme of the worker on site described above, it is not necessary to manage individual road deterioration in a narrow range. Note that PTL 1 does not disclose managing road deterioration on a map.

An object of the present disclosure is to provide a road deterioration diagnosis device, a road deterioration diagnosis method, and a recording medium capable of solving the above-described problems and efficiently managing road deterioration in accordance with a maintenance scheme.

### Solution to Problem

A first road deterioration diagnosis device in one aspect of the present disclosure includes a storage means for store deterioration information including a detection status of a pothole and a maintenance status of the detected pothole in each section obtained by dividing a predetermined region by a predetermined size, and a display control means for causing a display means to display a map indicating the deterioration information in the each section.

A second road deterioration diagnosis device in one aspect of the present disclosure includes a storage means for storing deterioration information including a detection status of road deterioration and a maintenance status of the detected road deterioration in each section obtained by dividing a predetermined region by a predetermined size, an update means for, when road deterioration is detected in a section in which the detection status is undetected, setting “detected” to a detection status of the section, updating the maintenance status of the section in accordance with a status of maintenance of the road deterioration, and updating the detection status to “undetected” after a lapse of a predetermined period from when the maintenance status is updated to a predetermined status, and a display control means for causing a display means to display a map indicating the deterioration information in the each section.

A road deterioration diagnosis method according to one aspect of the present disclosure includes storing deterioration information including a detection status of a pothole and a maintenance status of the detected pothole in each section obtained by dividing a predetermined region by a predetermined size, and causing a display means to display a map indicating the deterioration information in the each section.

A recording medium according to one aspect of the present disclosure records a program for causing a computer to execute processing of storing deterioration information including a detection status of a pothole and a maintenance status of the detected pothole in each section obtained by dividing a predetermined region by a predetermined size, and causing a display means to display a map indicating the deterioration information in the each section.

### Advantageous Effects of Invention

An effect of the present disclosure is that road deterioration can be efficiently managed in accordance with a maintenance scheme.

### BRIEF DESCRIPTION OF DRAWINGS

FIG. 1 is a block diagram illustrating a configuration of a road deterioration diagnosis system 10 in a first example embodiment

FIG. 2 is a block diagram illustrating an example of a configuration of a road deterioration diagnosis device 20 in the first example embodiment.

FIG. 3 is a view illustrating an example of sensor information in the first example embodiment.

FIG. 4 is a view illustrating an example of a detection result of road deterioration in the first example embodiment.

FIG. 5 is a view illustrating an example of deterioration information in the first example embodiment.

FIG. 6 is a view illustrating an example of a confirmation result of road deterioration in the first example embodiment.

FIG. 7 is a view illustrating an example of a repair result of road deterioration in the first example embodiment.

FIG. 8 is a flowchart illustrating road deterioration detection processing in the first example embodiment.

FIG. 9 is a flowchart illustrating maintenance status update processing in the first example embodiment.

FIG. 10 is a flowchart illustrating expiration date processing in the first example embodiment.

FIG. 11 is a view illustrating an example of time-series changes in a detection status and a maintenance status in deterioration information of a certain section in the first example embodiment.

FIG. 12 is a view illustrating another example of time-series changes in a detection status and a maintenance status in deterioration information of a certain section in the first example embodiment.

FIG. 13 is a flowchart illustrating road deterioration position display processing in the first example embodiment.

FIG. 14 is a view illustrating a display example of deterioration information onto a map in the first example embodiment.

FIG. 15 is a view illustrating a display example of detailed information of deterioration information in the first example embodiment.

FIG. 16 is a block diagram illustrating a configuration of a road deterioration diagnosis device 1 in a second example embodiment.

FIG. 17 is a block diagram illustrating an example of a hardware configuration of a computer 500.

### EXAMPLE EMBODIMENT

### First Example Embodiment

The first example embodiment will be described.

(System Configuration)

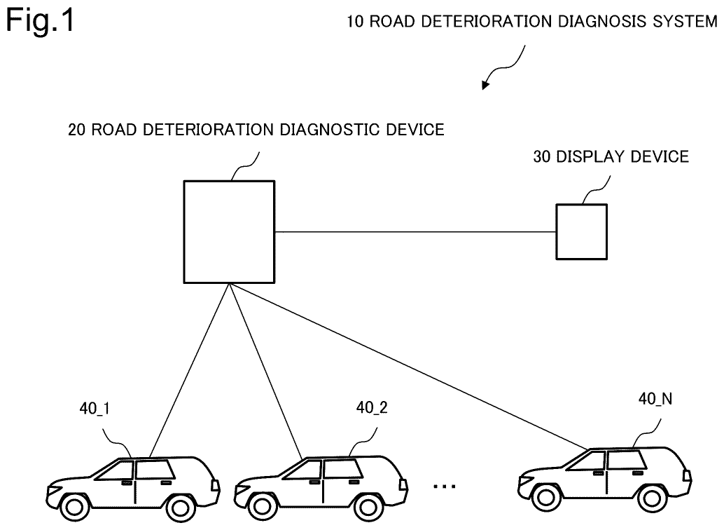

First, the configuration of the road deterioration diagnosis system in the first example embodiment will be described. FIG. 1 is a block diagram illustrating the configuration of the road deterioration diagnosis system 10 in the first example embodiment. With reference to FIG. 1, the road deterioration diagnosis system 10 includes the road deterioration diagnosis device 20, a display device 30, and a plurality of vehicles 40_1, 40_2, . . . 40_N (N is a natural number) (hereinafter, collectively referred to as vehicle 40) that are moving objects. The moving object may be a motorcycle, a bicycle, a drone, a robot or a vehicle with a self-driving function, or a person (pedestrian).

The vehicle 40 acquires predetermined sensor information acquired by a mounted sensor. The sensor information includes an image, acceleration, acquisition date and time, and a position. The image is an image of a road surface of a road captured (acquired) by an imaging device such as a dashboard camera mounted on the vehicle 40, for example, while traveling on the road. The acceleration is an expression of unevenness of a road surface of a road detected (acquired) by, for example, an acceleration sensor as vibration in the up-down direction while traveling on the road. The position is a position acquired by a position detection sensor such as a global positioning system (GPS) when an image is captured by the imaging device or when acceleration is acquired by the acceleration sensor. The vehicle 40 transmits, to the road deterioration diagnosis device 20, sensor information including an image, acceleration, acquisition date and time of these pieces of information, and a position. For example, latitude and longitude may be used as the position. In the present example embodiment, a case where both an image and acceleration are included in the sensor information will be described, but the present invention is not limited to this, and at least any one of the image and the acceleration may be included.

The road deterioration diagnosis device 20 detects road deterioration based on sensor information transmitted from the vehicle 40. Here, the road deterioration diagnosis device 20 divides the ground surface of each region into sections, and manages the detected road deterioration in each section. The road deterioration diagnosis device 20 presents the deterioration information to the user of the road deterioration diagnosis device 20 by causing the display device 30 to display the deterioration information for each section. Here, the user is, for example, a staff member (manager or worker) of the business operator.

The road deterioration diagnosis device 20 and the display device are disposed, for example, in an equipment management facility of the business operator. The road deterioration diagnosis device 20 and the display device 30 may be integrated or separate. The road deterioration diagnosis device 20 may be disposed in a place other than the equipment management facility of the business operator. In this case, the road deterioration diagnosis device 20 may be achieved by a cloud computing system. The display device 30 is one example embodiment of the display means of the present disclosure.

As a detection method of a road result based on sensor information, a known technique using image analysis or acceleration is used. Examples of detection of road deterioration using image analysis include a method of analyzing road deterioration using artificial intelligence (AI). Examples of detection of road deterioration using acceleration include a method of detecting a degree of unevenness of a road surface using acceleration in a direction perpendicular to the road surface.

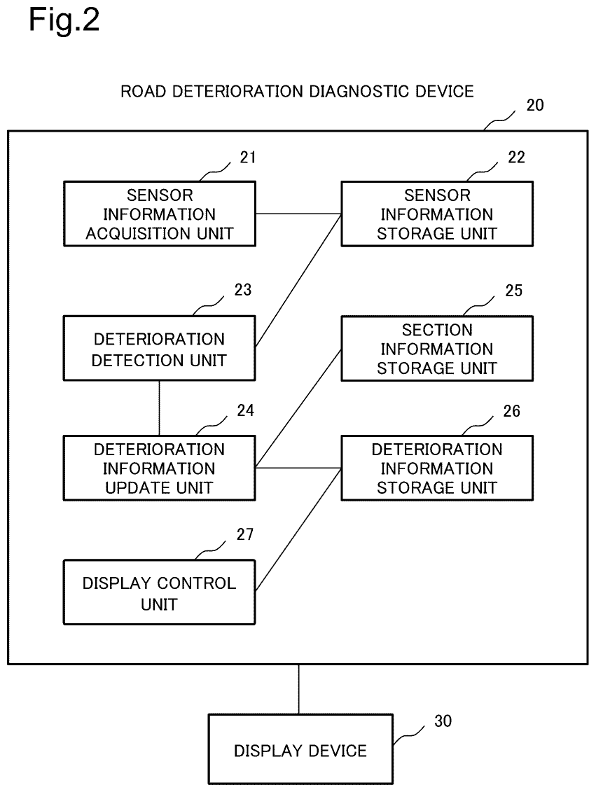

FIG. 2 is a block diagram illustrating an example of the configuration of the road deterioration diagnosis device 20 in the first example embodiment. As illustrated in FIG. 2, the road deterioration diagnosis device 20 includes a sensor information acquisition unit 21, a sensor information storage unit 22, a deterioration detection unit 23, a deterioration information update unit 24, a section information storage unit 25, a deterioration information storage unit 26, and a display control unit 27. The section information storage unit 25, the deterioration information update unit 24, and the display control unit 27 are one example embodiment of the storage means, the update means, and the display control means of the present disclosure.

The sensor information acquisition unit 21 acquires sensor information from the vehicle 40. The sensor information acquisition unit 21 outputs the acquired sensor information to the sensor information storage unit 22.

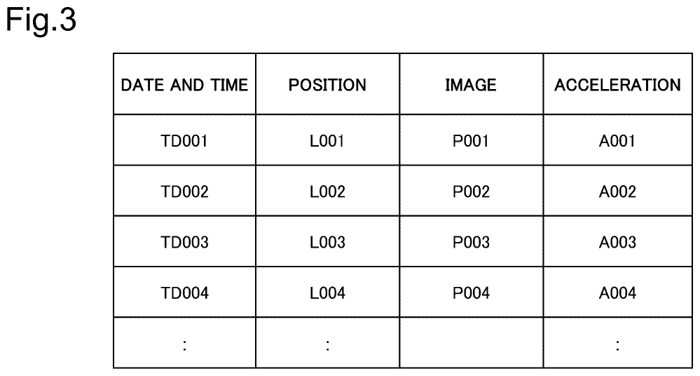

The sensor information storage unit 22 stores the sensor information output by the sensor information acquisition unit 21. FIG. 3 is a view illustrating an example of sensor information in the first example embodiment. In the example of FIG. 3, the sensor information includes date and time, a position, an image, and acceleration. The date and time indicates the date and time when the vehicle 40 acquires the image and the acceleration. The position indicates the position where the image and the acceleration are acquired.

The deterioration detection unit 23 detects road deterioration based on at least one of the image and the acceleration included in the sensor information. Here, the deterioration detection unit 23 detects, for example, a pothole as road deterioration. The pothole refers to a hole having a diameter of about 0.1 to 1 m, for example, generated on a pavement surface of a road surface. The deterioration detection unit 23 is not limited to this, and may detect a crack, rutting, or the like as road deterioration. The deterioration detection unit 23 may detect road deterioration based on an index indicating road deterioration. In this case, as the index, for example, a cracking rate, a rutting amount, flatness, a maintenance control index (MCI), an international roughness index (IRI), or the like is used. The deterioration detection unit 23 detects the index as road deterioration when the value of the index exceeds a predetermined threshold.

Hereinafter, in the first example embodiment, a case where the deterioration detection unit 23 detects a pothole as road deterioration will be described as an example.

The deterioration detection unit 23 outputs a detection result of detected road deterioration to the deterioration information update unit 24.

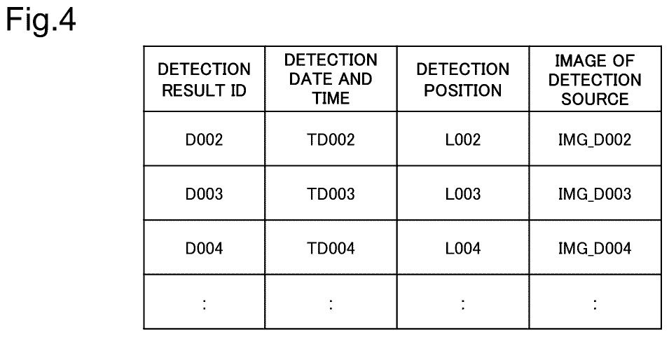

FIG. 4 is a view illustrating an example of a detection result of road deterioration in the first example embodiment. In the example of FIG. 4, the detection result includes detection date and time, a detection position, and an image of a detection source. Here, the detection date and time, the detection position, and the image of the detection source are the date and time, the position, and the image, respectively, included in the sensor information in which the road deterioration (pothole) is detected.

The deterioration information update unit 24 specifies a section in which road deterioration has been detected based on a position included in the sensor information in which the road deterioration has been detected and information on a section (mesh) stored in the section information storage unit 25. Then, the deterioration information update unit 24 sets and updates the deterioration information of each section stored in the deterioration information storage unit 26 based on the detection result of the road deterioration acquired from the deterioration detection unit 23.

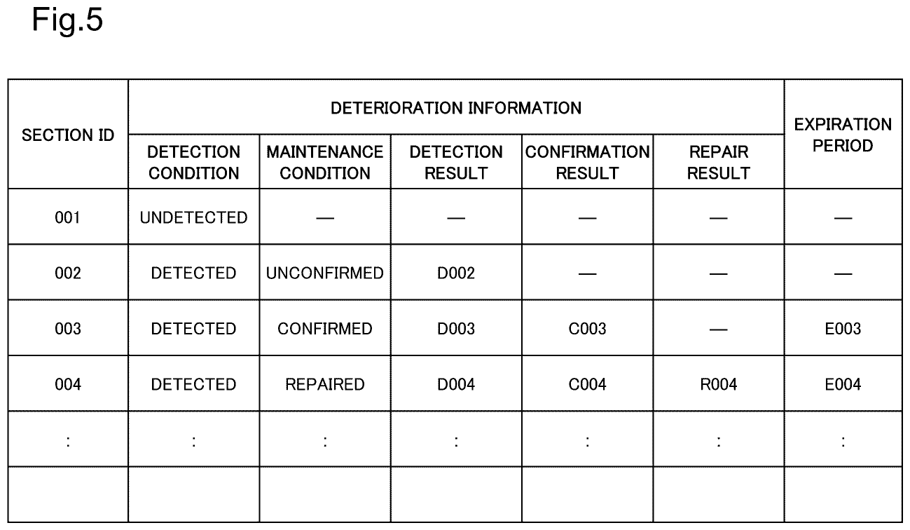

FIG. 5 is a view illustrating an example of deterioration information in the first example embodiment. In the example of FIG. 5, the deterioration information includes a detection status, a maintenance status, a detection result, a confirmation result, a repair result, and an expiration date.

The detection status is an item indicating whether road deterioration has been detected in a certain section. As the detection status, “undetected” indicating that road deterioration has not been detected or “detected” indicating that road deterioration has been detected is set.

The maintenance status is an item indicating the status of maintenance with respect to road deterioration in a certain section. As the maintenance status, “unconfirmed” indicating that road deterioration has not been confirmed on site (waiting for confirmation), “confirmed” indicating that road deterioration has been confirmed on site (waiting for repair), and “repaired” indicating that repair has been performed are set. Hereinafter, the maintenance statuses “unconfirmed”, “confirmed”, and “repaired” are also described as a first status, a second status, and a third status, respectively.

The detection result of road deterioration described above is set as the detection result.

As the confirmation result and the repair result, a confirmation result on site by a worker or the like and a repair result are set, respectively. The confirmation result and the repair result are transmitted from, a mobile terminal or the like of the worker that is not illustrated, for example.

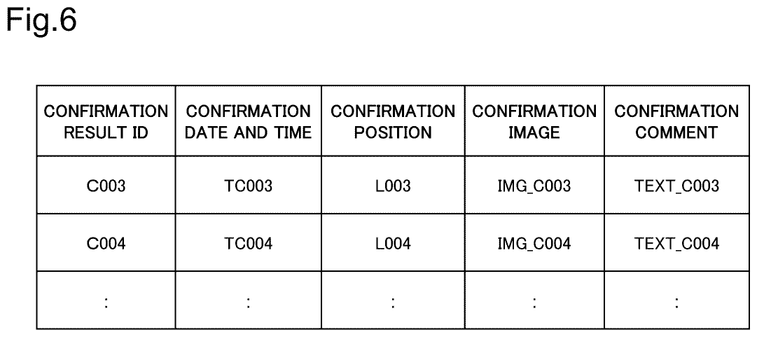

FIG. 6 is a view illustrating an example of a confirmation result of road deterioration in the first example embodiment. In the example of FIG. 6, the confirmation result includes a confirmation date and time, a confirmation position, a confirmation image, and a confirmation comment. Here, the confirmation date and time, the confirmation position, the confirmation image, and the confirmation comment are the date and time when the confirmation work of road deterioration is performed, the position, the image of the confirmed road deterioration, and the comment of the worker who confirms, respectively.

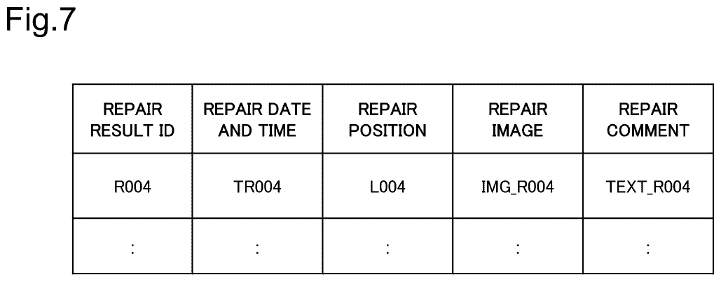

FIG. 7 is a view illustrating an example of a repair result of road deterioration in the first example embodiment. In the example of FIG. 7, the repair result includes a repair date and time, a repair position, a repair image, and a repair comment. Here, the repair date and time, the repair position, the repair image, and the repair comment are the date and time when the repair work of road deterioration is performed, the position, the image of repaired road deterioration, and the comment of the worker who repairs, respectively.

The expiration date of the deterioration information is set as the expiration date. Here, in the deterioration information whose maintenance status is “confirmed”, date and time after a predetermined confirmed validity period from the date and time when the maintenance status is updated to “confirmed” is set as the expiration date. In the deterioration information whose maintenance status is “repaired”, date and time after a predetermined repaired validity period from the date and time when the maintenance status is updated to “repaired” is set as the expiration date. Hereinafter, the confirmed validity period and the repaired validity period are also described as a first validity period and a second validity period, respectively. The confirmed validity period and the repaired validity period are set in advance in accordance with predetermined conditions (e.g., repair history, traffic volume, material, and the like of the road of the section).

When road deterioration is detected in a section whose detection status is “undetected”, the deterioration information update unit 24 sets “detected” to the detection status of the section.

The deterioration information update unit 24 updates the maintenance status of the deterioration information of the section in accordance with the status of maintenance of the road deterioration of the section. When the expiration date of the deterioration information of the section has been passed, the deterioration information update unit 24 initializes the deterioration information of the section (sets “undetected” to detection status).

In the example of FIG. 5, no pothole has been detected in a section ID “001”, and the detection status “undetected” is set in the deterioration information. In a section ID “002”, since a pothole has been detected and confirmation on site has not been performed, the detection status “detected”, the maintenance status “unconfirmed”, and a detection result are set in the deterioration information. In a section ID “003”, since a pothole has been detected and confirmation on site has been performed, the detection status “detected”, the maintenance status “confirmed”, a detection result, a confirmation result, and an expiration date “E003” based on the confirmed validity period are set in the deterioration information. In a section ID “004”, since a pothole has been detected and repair is performed, the detection status “detected”, the maintenance status “repaired”, a detection result, a confirmation result, a repair result, and an expiration date “E004” based on the repaired validity period are set in the deterioration information.

The section information storage unit 25 stores, as information of the section (mesh), for example, a section (mesh) obtained by dividing the ground surface of each region by a predetermined size based on the latitude and longitude lines, and a section identifier (ID) (mesh code) for identifying each of the sections. As the size of the section, for example, a size that can be visually confirmed by a worker who performs maintenance on site is used. For example, as the section and the section ID, a standard region mesh created by an administrative agency such as a national government, a divided region mesh obtained by further subdividing the standard region mesh, or a region mesh obtained by further subdividing the divided region mesh is used. As the region mesh, for example, a mesh having a side length of about 15.6 m or a mesh shorter than that may be used.

The deterioration information storage unit 26 stores deterioration information of each section. As illustrated in FIG. 5, the deterioration information storage unit 26 stores deterioration information of each section in association with the section ID of the section.

The display control unit 27 acquires the deterioration information from the deterioration information storage unit 26, and causes the display device 30 to display the deterioration information for each section in a predetermined display aspect, for example.

Next, the operation of the first example embodiment will be described.

(Road Deterioration Detection Processing)

The road deterioration detection processing will be described. The road deterioration detection processing is processing of updating deterioration information for each section regarding road deterioration detected based on sensor information transmitted from each vehicle 40. Hereinafter, the road deterioration detection processing will be described using the sensor information of FIG. 3 and the deterioration information of FIG. 5.

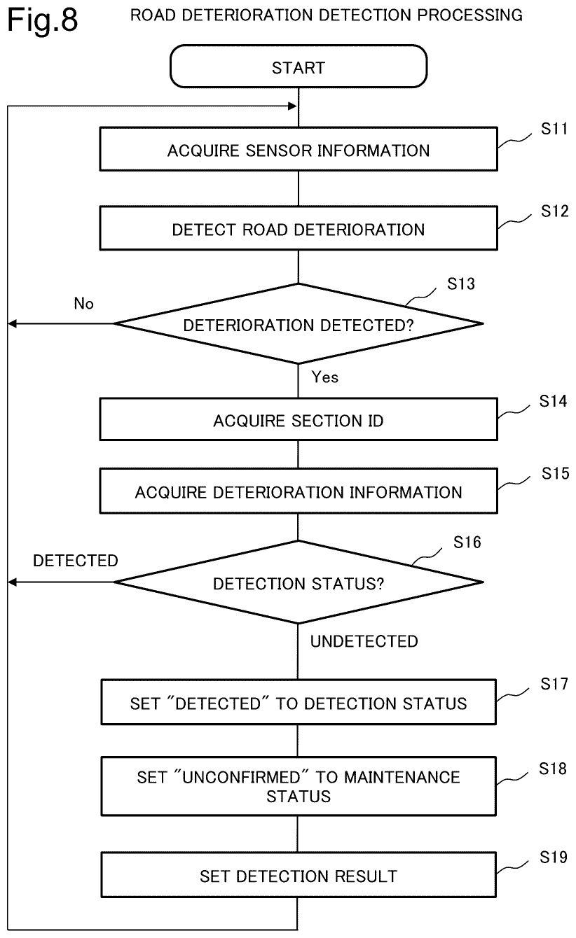

FIG. 8 is a flowchart illustrating road deterioration detection processing in the first example embodiment. The sensor information acquisition unit 21 of the road deterioration diagnosis device 20 acquires sensor information (date and time, position, image, and acceleration) transmitted from the vehicle 40, for example (step S11). For example, the sensor information acquisition unit 21 acquires sensor information as illustrated in FIG. 3. The sensor information acquisition unit 21 stores the acquired sensor information in the sensor information storage unit 22.

The deterioration detection unit 23 acquires the sensor information from the sensor information storage unit 22, and detects road deterioration at the position of the sensor information based on the acquired sensor information (step S12). When road deterioration is detected (step S13/Yes), the deterioration detection unit 23 outputs the detection result to the deterioration information update unit 24. For example, when a pothole is detected by the sensor information of date and time “TD002” in FIG. 3, the deterioration detection unit 23 outputs a detection result “D002” in FIG. 4 to the deterioration information update unit 24.

When road deterioration is not detected (step S13/No), the processing from step S11 is repeated.

Based on the detection result, the deterioration information update unit 24 acquires the section ID of the section in which the road deterioration is detected (step S14). Here, with reference to the section information stored in the section information storage unit 25, the deterioration information update unit 24 determines the section including the detection position of the road deterioration, and acquires the section ID of the section. For example, the deterioration information update unit 24 acquires the section ID “002” of the section including a detection position “L002” of the detection result ID “D002”.

The deterioration information update unit 24 acquires the deterioration information of the section where the road deterioration is detected, the deterioration information being stored in the deterioration information storage unit 26 (step S15).

When the detection status of the acquired deterioration information is “undetected” (step S16/undetected), the deterioration information update unit 24 sets “detected” to the detection status of the deterioration information (step S17). The deterioration information update unit 24 sets “unconfirmed” to the maintenance status of the deterioration information (step S18). The deterioration information update unit 24 sets the detection result acquired from the deterioration detection unit 23 to the deterioration information (step S19).

For example, in a case where the detection result “D002” is obtained when the detection status of the section “002” is “undetected”, the deterioration information of the section “002” is set as in FIG. 5. In this case, the deterioration information update unit 24 may notify, via the display device 30 or the like, the user that “detected” is set to the detection status of the deterioration information (that road deterioration is detected in the section). Thereafter, the processing from step S11 is repeated.

When the detection status of the acquired deterioration information is “detected” (step S16/detected), the processing from step S11 is repeated without updating the detection status and the maintenance status of the deterioration information.

(Maintenance Status Update Processing)

The maintenance status update processing will be described. The maintenance status update processing is processing of updating the maintenance status of the deterioration information in accordance with the status of maintenance of the detected road deterioration. The maintenance status update processing is executed when the road deterioration diagnosis device 20 acquires a confirmation result or a repair result of road deterioration transmitted from a mobile terminal or the like of the worker.

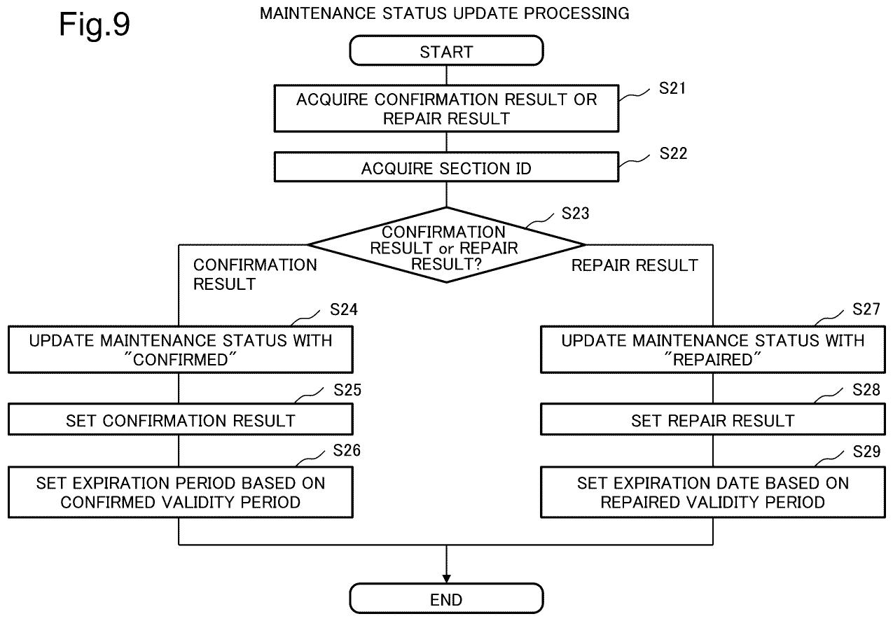

FIG. 9 is a flowchart illustrating maintenance status update processing in the first example embodiment. The deterioration information update unit 24 of the road deterioration diagnosis device 20 acquires a confirmation result or a repair result (step S21).

The deterioration information update unit 24 acquires the section ID of the section where the confirmation or the repair has been performed based on the confirmation result or the repair result (step S22). Here, with reference to the section information stored in the section information storage unit 25, the deterioration information update unit 24 determines the section including the confirmation position or the repair position, and acquires the section ID of the section. When the acquired confirmation result or repair result includes the section ID of the section where confirmation or repair has been performed, the deterioration information update unit 24 may use the section ID.

When acquiring the confirmation result (step S23/confirmation result), the deterioration information update unit 24 updates the maintenance status of the deterioration information of the confirmed section with “confirmed” (step S24). The deterioration information update unit 24 sets the confirmation result to the deterioration information (step S25). The deterioration information update unit 24 sets an expiration date based on the confirmed validity period to the expiration date of the deterioration information (step S26).

For example, in a case where a confirmation result of a section “003” is obtained when the maintenance status of the section is “unconfirmed”, the deterioration information of the section “003” is updated as in FIG. 5.

When acquiring the repair result (step S23/repair result), the deterioration information update unit 24 updates the maintenance status of the deterioration information of the section where the repair has been performed with “repaired” (step S27). The deterioration information update unit 24 sets the repair result to the deterioration information (step S28). The deterioration information update unit 24 sets an expiration date based on the repaired validity period to the expiration date of the deterioration information (step S29).

For example, in a case where a repair result of a section “004” is obtained when the maintenance status of the section is “confirmed”, the deterioration information of the section “004” is updated as in FIG. 5.

(Expiration Date Processing)

The expiration date processing will be described. The expiration date processing is processing for initializing the deterioration information of each section when the expiration date of the deterioration information of each section has been passed. The expiration date processing is repeatedly executed every predetermined period.

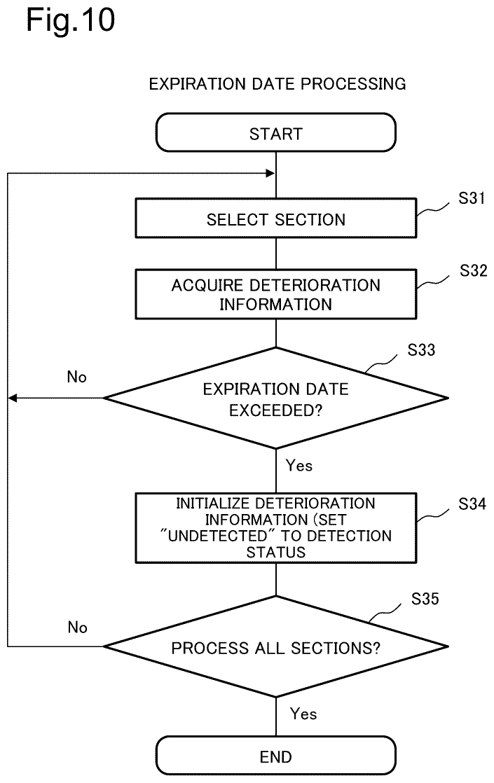

FIG. 10 is a flowchart illustrating expiration date processing in the first example embodiment.

The deterioration information update unit 24 selects one section (step S31).

The deterioration information update unit 24 acquires the deterioration information of the selected section from the deterioration information storage unit 26 (step S32).

When the current time has passed the expiration date in the deterioration information of the selected section (step S33/Yes), the deterioration information update unit 24 initializes the deterioration information. That is, the deterioration information update unit 24 sets “undetected” to the detection status of the deterioration information and erases information other than the detection status (step S34). In this case, the deterioration information update unit 24 may notify, via the display device 30 or the like, the user that “undetected” is set to the detection status of the deterioration information (maintenance status in the section has exceeded the expiration date of “confirmed” or “repaired”).

The deterioration information update unit 24 may store the deterioration information before initialization into a storage unit not illustrated. Due to this, as described later, even after the expiration date has been passed, the deterioration information of the maintenance status “confirmed” or “repaired” that has passed the expiration date can be presented to the user.

The deterioration information update unit 24 repeats the processing from step S31 for all the sections stored in the deterioration information storage unit 26 (step S35).

(Specific Example of Deterioration Information Update)

Here, a specific example of the deterioration information update associated with the road deterioration detection processing, the maintenance status update processing, and the expiration date processing described above will be described.

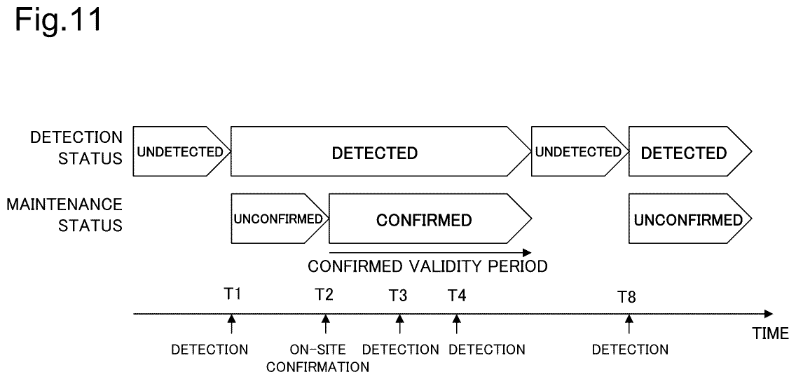

FIG. 11 is a view illustrating an example of time-series changes in the detection status and the maintenance status in deterioration information of a certain section in the first example embodiment.

As illustrated in FIG. 11, when a pothole is detected in the section based on the sensor information that the vehicle 40 has traveled in the section at time T1, the deterioration information update unit 24 sets “detected” to the detection status (step S17) and sets “unconfirmed” to the maintenance status (step S18).

Next, when the worker confirms the pothole on site at time T2, the deterioration information update unit 24 updates the maintenance status with “confirmed” (step S24) and sets the expiration date based on the confirmed validity period (step S26).

Thereafter, based on the sensor information at times T3 and T4 before the expiration date is passed, even if a pothole is detected at the same position as or a different position from that at the time T1 in the section, the detection status “detected” and the maintenance status “confirmed” are maintained.

Next, when the expiration date is passed, the deterioration information update unit 24 initializes the deterioration information (sets “undetected” to the detection status) (step S34).

When a pothole is detected in the section based on the sensor information that the vehicle 40 has traveled in the section at time T8, the deterioration information update unit 24 sets “detected” to the detection status (step S17) and sets “unconfirmed” to the maintenance status (step S18).

In the present example embodiment, in this manner, when “confirmed” is set to the maintenance status of the deterioration information, even if a pothole is detected, the detection status “detected” and the maintenance status “confirmed” are maintained. Therefore, it is possible to prevent a situation of unnecessarily managing information on a confirmed pothole and other potholes that can be confirmed or repaired at the time of repairing the pothole, the information detected when the vehicle 40 repeatedly travels.

In the present example embodiment, in this manner, when the expiration date is passed, “undetected” is set to the detection status, and at the time point when the pothole is detected again, the detection status “detected” and the maintenance status “unconfirmed” are set. Therefore, even if the confirmed pothole is not repaired, the information on the pothole is managed again by the vehicle 40 repeatedly traveling, and thus it is possible to prevent the situation where the pothole is left.

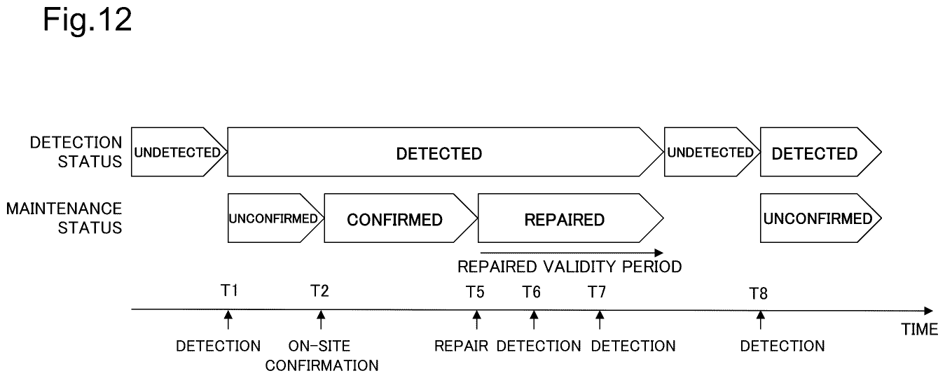

FIG. 12 is a view illustrating another example of time-series changes in the detection status and the maintenance status in deterioration information of a certain section in the first example embodiment.

In FIG. 12, similarly to FIG. 11, the deterioration information update unit 24 sets “detected” to the detection status and “unconfirmed” to the maintenance status at the time T1 (steps S17 and S18), and updates the maintenance status with “confirmed” at the time T2 (step S24).

Next, when the worker repairs the pothole on site at time T5, the deterioration information update unit 24 updates the maintenance status with “repaired” (step S27) and sets the expiration date based on the repaired validity period (step S29).

Thereafter, based on the sensor information at times T6 and T7 before the expiration date is passed, even if a pothole is detected at the same position as or a different position from that at the time T1 in the section, the detection status “detected” and the maintenance status “repaired” are maintained.

Next, when the expiration date is passed, the deterioration information update unit 24 initializes the deterioration information (sets “undetected” to the detection status) (step S34).

Similarly to FIG. 11, the deterioration information update unit 24 sets “detected” to the detection status and “unconfirmed” to the maintenance status at the time T8 (steps S17 and S18).

In general, in deterioration detection by an image, there is a possibility that a repair trace of a pothole is erroneously detected as a pothole for a while after repair.

In the present example embodiment, in this manner, when “repaired” is set to the maintenance status of the deterioration information, even if a pothole is detected, the detection status “detected” and the maintenance status “repaired” are maintained. Therefore, it is possible to prevent a status of providing unnecessary information due to erroneous detection of a repair trace of the pothole as a pothole when the vehicle 40 repeatedly travels in a place having the repair trace.

In order to further reduce such erroneous detection of a pothole, the deterioration detection unit 23 may use a value stricter than usual as a detection threshold of deterioration detection by an image during a repaired validity period.

(Road Deterioration Position Display Processing)

The road deterioration position display processing will be described. The road deterioration position display processing is processing of displaying deterioration information on a map.

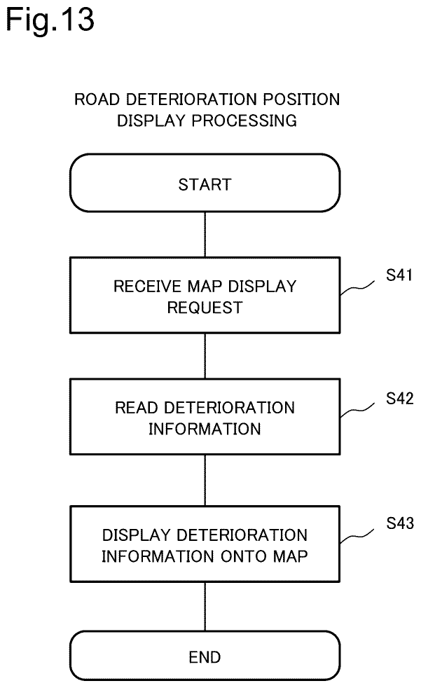

FIG. 13 is a flowchart illustrating road deterioration position display processing in the first example embodiment. The display control unit 27 receives a map display request from the user of the road deterioration diagnosis device 20 (step S41).

The display control unit 27 acquires the deterioration information of each section stored in the deterioration information storage unit 26 (step S42).

The display control unit 27 displays the acquired deterioration information of each section on the map (step S43). Here, for example, the display control unit 27 displays the detection status and the maintenance status at a position included in the detection result of the deterioration information of each section.

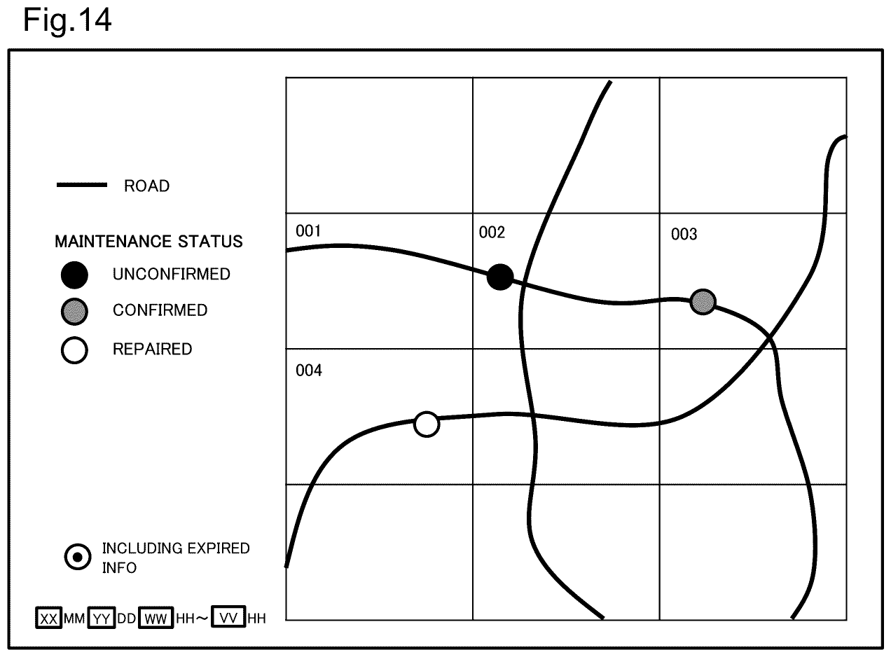

FIG. 14 is a view illustrating a display example of deterioration information onto a map in the first example embodiment. The example of FIG. 14 is associated to the deterioration information of FIG. 5. For example, as in FIG. 14, the display control unit 27 displays an icon corresponding to the maintenance status at the position where the pothole is detected in each section of the detection status “detected”. In the example of FIG. 14, the maintenance statuses “unconfirmed”, “confirmed”, and “repaired” are displayed in round icons with colors of “black”, “gray”, and “white”, respectively.

In the example of FIG. 14, a radio button “including expired” for designating display of deterioration information that has passed the expiration date, and a field for designating a range of the expiration date are displayed. When the display of the deterioration information that has passed the expiration date is designated together with the range of the expiration date, the display control unit 27 may also display, on the map, the deterioration information within the range in which the expiration date is designated among the deterioration information that has passed the expiration date stored in a storage unit not illustrated. In this case, the display control unit 27 may display the deterioration information that has passed the expiration date in an aspect different from that of other deterioration information.

For example, when the user clicks or hovers the pointer over the icon, the display control unit 27 may display detailed information such as a detection result, a confirmation result, a repair result, and an expiration date in addition to the detection status and the maintenance status of the deterioration information associated to the section of the icon. Here, the detection date and time, the image of the detection source, the confirmation date and time, the confirmation image, the maintenance date and time, and the repair image may be displayed as the detailed information.

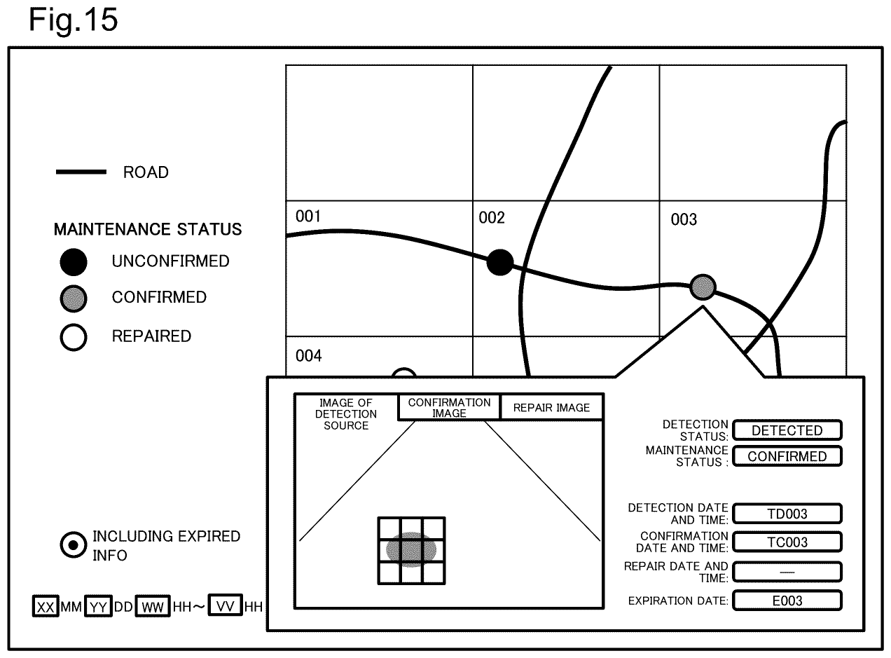

FIG. 15 is a view illustrating a display example of detailed information of deterioration information in the first example embodiment. In FIG. 15, when the icon for the maintenance status “confirmed” of the section ID “003” is clicked or the pointe hovers over the icon, the detailed information on the deterioration information of the section is displayed.

Thus, the operation of the first example embodiment is completed.

In the first example embodiment, a case where a pothole is detected as road deterioration, and the detection status and the maintenance status of the pothole for each section are managed has been described as an example. However, the present invention is not limited to this, and other road deterioration (crack, rutting, and the like) or road deterioration based on an index (cracking rate, rutting amount, flatness, MCI, IRI, and the like) may be detected as the road deterioration, and the detection status and the maintenance status of the road deterioration for each section may be managed.

(Effects of First Example Embodiment)

According to the first example embodiment, road deterioration can be efficiently managed in accordance with a maintenance scheme. This is because the deterioration information storage unit 26 of the road deterioration diagnosis device 20 stores, for each section obtained by dividing a predetermined region by a predetermined size, deterioration information including a detection status indicating presence or absence of detection of road deterioration in the section and a maintenance status of the detected road deterioration, and the display control unit 27 causes the display device 30 to display a map indicating the deterioration information in each section. This can prevent a situation where management becomes complicated as in a case of managing individual road deterioration in a maintenance scheme in which a worker simultaneously confirms and repairs on site road deterioration around a position where the road deterioration is detected. For example, a case of managing a pothole among road deterioration is an example in which such a maintenance scheme is taken based on the degree of urgency of repair.

### Second Example Embodiment

The second example embodiment will be described.

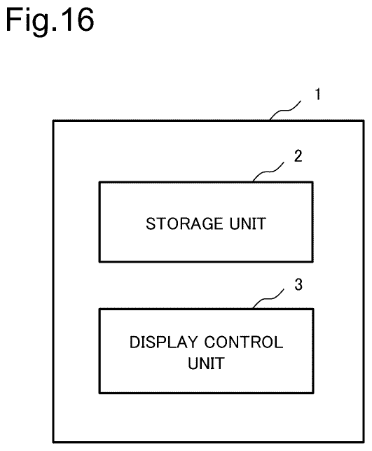

FIG. 16 is a block diagram illustrating the configuration of the road deterioration diagnosis device 1 in the second example embodiment. With reference to FIG. 16, the road deterioration diagnosis device 1 includes a storage unit 2 and a display control unit 3. The storage unit 2 and the display control unit 3 are an example embodiment of the storage means and the display control means, respectively.

The storage unit 2 stores, for each section obtained by dividing a predetermined region by a predetermined size, deterioration information including a detection status indicating the presence or absence of detection of a road deterioration in the section and a maintenance status of the detected road deterioration. The display control unit 3 causes the display means to display a map indicating the deterioration information in each section.

Next, effects of the second example embodiment will be described.

According to the second example embodiment, road deterioration can be efficiently managed in accordance with a maintenance scheme. This is because the storage unit 2 stores, for each section obtained by dividing a predetermined region by a predetermined size, deterioration information including a detection status indicating presence or absence of detection of road deterioration in the section and a maintenance status of the detected road deterioration, and the display control unit 3 causes the display means to display a map indicating the deterioration information in each section.

(Hardware Configuration)

In each of the above-described example embodiments, each component of the road deterioration diagnosis devices 1 and 20 indicates a block of a functional unit. Some or all of the components of each device may be implemented by a discretionary combination of the computer 500 and a program. This program may be recorded in a non-volatile recording medium. The non-volatile recording medium is, for example, a compact disc read only memory (CD-ROM), a digital versatile disc (DVD), a solid state drive (SSD), or the like.

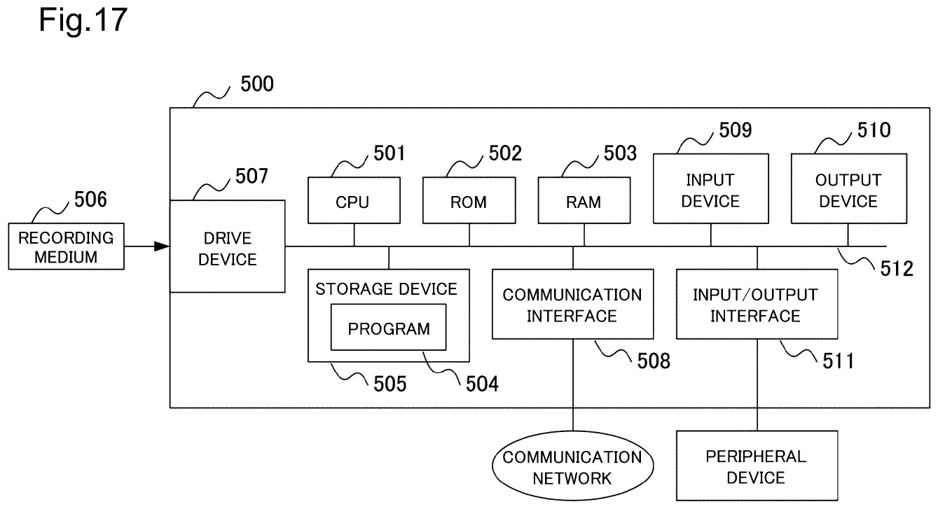

FIG. 17 is a block diagram illustrating an example of the hardware configuration of the computer 500. With reference to FIG. 17, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for implementing the functions of each device. The program 504 is stored in advance in the ROM 502, the RAM 503, and the storage device 505. The CPU 501 implements the functions of each device by executing an instruction included in the program 504. For example, by executing an instruction included in the program 504, the CPU 501 of the road deterioration diagnosis device 20 implements the functions of the sensor information acquisition unit 21, the deterioration detection unit 23, the deterioration information update unit 24, and the display control unit 27. The RAM 503 may store data to be processed in the functions of each device. For example, the RAM 503 of the road deterioration diagnosis device 20 may store data (sensor information) of the sensor information storage unit 22, data (section information) of the section information storage unit 25, data (deterioration information) of the deterioration information storage unit 26, and the like.

The drive device 507 reads and writes a recording medium 506. The communication interface 508 provides an interface with a communication network. The input device 509 is, for example, a mouse, a keyboard, or the like, and receives input of information from an operator or the like. The output device 510 is, for example, a display, and outputs (displays) information to the operator or the like. The input/output interface 511 provides an interface with peripheral equipment. The bus 512 connects those components of the hardware. The program 504 may be supplied to the CPU 501 via a communication network, or may be stored in the recording medium 506 in advance, read by the drive device 507, and supplied to the CPU 501.

The hardware configuration illustrated in FIG. 17 is an example, and other components may be added, and some components need not be included.

There are various modifications for the implementation method of each device. For example, each device may be implemented by a discretionary combination of a computer and a program different for each component. A plurality of components included in each device may be implemented by a discretionary combination of a computer and a program.

Some or all of the components of each device may be implemented by a general-purpose or special-purpose circuitry including a processor, or a combination of them. These circuitries may be configured by a single chip or may be configured by a plurality of chips connected via the bus. Some or all of the components of each device may be implemented by a combination of the above-described circuitry and the like and a program.

When some or all of the components of each device are implemented by a plurality of computers, circuitries, and the like, the plurality of computers, circuitries, and the like may be centralized or decentralized.

While the present disclosure has been described with reference to example embodiments, the present disclosure is not limited to the example embodiments. Various changes that can be understood by those of ordinary skill in the art can be made in the configuration and details of the present disclosure. The configuration in each of the example embodiments can be combined with one another without departing from the scope of the present disclosure.

### REFERENCE SIGNS LIST

1, 20 road deterioration diagnosis device
2 storage unit
3, 27 display control unit
10 road deterioration diagnosis system
21 sensor information acquisition unit
22 sensor information storage unit
23 deterioration detection unit
24 deterioration information update unit
25 section information storage unit
26 deterioration information storage unit
500 computer
501 CPU
502 ROM
503 RAM
504 program
505 storage device
506 recording medium
507 drive device
508 communication interface
509 input device
510 output device
511 input/output interface
512 bus

What is claimed is:

1. A road deterioration diagnosis device comprising:
at least one memory configured to store instructions, deterioration information including a detection status of a pothole, and a maintenance status of the detected pothole in each section, the each section obtained by dividing a predetermined region by a predetermined size; and
at least one processor configured to execute the instructions to cause a display to display a map indicating the deterioration information in the each section.

2. The road deterioration diagnosis device according to claim 1 wherein the at least one processor is further configured to execute the instructions to:
in a case that a pothole is detected in a section in which the detection status indicates undetected, set a status indicating “detected” as the detection status of the section;
update the maintenance status of the section in accordance with the maintenance status of the pothole, and pothole;
set a status indicating “undetected” as the detection status of the section after a predetermined period elapses since the maintenance status is updated to a predetermined status; and
cause the display to display the map indicating the deterioration information in which the detection status is detected.

3. The road deterioration diagnosis device according to claim 2, wherein the at least one processor is further configured to execute the instructions to:
in a case that the pothole is detected in a section in which the detection status indicates undetected, set a first status as the maintenance status of the section, the first status indicating that the pothole is unconfirmed.

4. The road deterioration diagnosis device according to claim 2, wherein the at least one processor is further configured to execute the instructions to:
in a case that a pothole in the section is confirmed, update the maintenance status of the section with a second status indicating that the pothole is confirmed, and
after a first period elapses since the maintenance status is updated to the second status, set a status indicating “undetected” as the detection status of the section.

5. The road deterioration diagnosis device according to claim 2, wherein the at least one processor is further configured to execute the instructions to:
in a case that a pothole in the section is repaired, update the maintenance status of the section with a third status indicating that the pothole is repaired, and
after a second period elapses since the maintenance status is updated to the third status, set a status indicating “undetected” as the detection status of the section.

6. The road deterioration diagnosis device according to claim 2, wherein the at least one processor is further configured to execute the instructions to:
cause the display to display the map indicating the deterioration information after the predetermined period has passed, in response to a user operation.

7. The road deterioration diagnosis device according to claim 1, wherein
the deterioration information includes an image of a detection source used for detection of the pothole, a confirmation image at a time of confirming the pothole, and a repair image at a time of repairing the pothole, and
wherein the at least one processor is further configured to execute the instructions to:
cause the display to display one or more of the image of the detection source, the confirmation image, and the repair image of the each section in response to a user operation.

8. (canceled)

9. A road deterioration diagnosis method comprising:
storing deterioration information including a detection status of a pothole and a maintenance status of the detected pothole in each section obtained by dividing a predetermined region by a predetermined size; and
causing a display to display a map indicating the deterioration information in the each section.

10. A recording medium storing a program for causing a computer to execute processing of:
storing deterioration information including a detection status of a pothole and a maintenance status of the detected pothole in each section obtained by dividing a predetermined region by a predetermined size; and
causing a display to display a map indicating the deterioration information in the each section.
